(19) United States
(12) Patent Application Publication
(10) Pub. No.: US 2022/0231466 A1
(43) Pub. Date: Jul. 21, 2022

(54) HYBRID CABLE ASSEMBLY WITH CIRCUIT BREAKING DEVICE FOR OVERVOLTAGE PROTECTION

(71) Applicant: CommScope Technologies LLC, Hickory, NC (US)

(72) Inventor: Nahid Islam, Westmont, IL (US)

(21) Appl. No.: 17/569,645

(22) Filed: Jan. 6, 2022

Related U.S. Application Data
(60) Provisional application No. 63/138,837, filed on Jan. 19, 2021.

(51) Int. Cl. H01R 13/66; H01R 13/68; H01B 7/18; H01B 7/04; G02B 6/42; G02B 6/44

(52) U.S. Cl. CPC H01R 13/6666; H01R 13/68; G02B 6/4416; H01B 7/04; G02B 6/4284; H01B 7/185

(57) ABSTRACT

A hybrid jumper cable assembly includes: a plurality of power conductors; a plurality of optical fibers; a jacket surrounding the power conductors and the optical fibers; one or more connectors connected with the power conductors and the optical fibers; and a fuse electrically connected with one of the plurality of power conductors.

### RELATED APPLICATION

The present application claims priority from and the benefit of U.S. Provisional Patent Application No. 63/138,837, filed Jan. 19, 2021, the disclosure of which is hereby incorporated herein by reference in its entirety.

### FIELD OF THE INVENTION

The present invention relates generally to remote radio heads, and more particularly to delivering power to remote radio heads at the top of antenna towers and/or in other locations that are remote from a power supply.

### BACKGROUND

Cellular base stations typically include, among other things, a radio, a baseband unit, and one or more antennas. The radio receives digital information and control signals from the baseband unit and modulates this information into a radio frequency (“RF”) signal that is then transmitted through the antennas. The radio also receives RF signals from the antenna and demodulates these signals and supplies them to the baseband unit. The baseband unit processes demodulated signals received from the radio into a format suitable for transmission over a backhaul communications system. The baseband unit also processes signals received from the backhaul communications system and supplies the processed signals to the radio. A power supply is provided that generates suitable direct current (“DC”) power signals for powering the baseband unit and the radio. The radio is often powered by a (nominal) −48 Volt DC power supply.

In order to increase coverage and signal quality, the antennas in many cellular base stations are located at the top of a tower, which may be, for example, about fifty to two hundred feet tall. In early cellular systems, the power supply, baseband unit and radio were all located in an equipment enclosure at the bottom of the tower to provide easy access for maintenance, repair and/or later upgrades to the equipment. Coaxial cable(s) were routed from the equipment enclosure to the top of the tower that carried signal transmissions between the radio and the antennas. However, in recent years, a shift has occurred and the radio is now more typically located at the top of the antenna tower and referred to as a remote radio head (“RRH”). Using remote radio heads may significantly improve the quality of the cellular data signals that are transmitted and received by the cellular base station, as the use of remote radio heads may reduce signal transmission losses and noise. In particular, as the coaxial cable runs up the tower may be 100-200 feet or more, the signal loss that occurs in transmitting signals at cellular frequencies (e.g., 1.8 GHz, 3.0 GHz, etc.) over the coaxial cable may be significant. Because of this loss in signal power, the signal-to-noise ratio of the RF signals may be degraded in systems that locate the radio at the bottom of the tower as compared to cellular base stations where remote radio heads are located at the top of the tower next to the antennas (note that signal losses in the cabling connection between the baseband unit at the bottom of the tower and the remote radio head at the top of the tower may be much smaller, as these signals are transmitted at baseband or as optical signals on a fiber optic cable and then converted to RF frequencies at the top of the tower).

FIG. 1 schematically illustrates a conventional cellular base station 10 in which the radios are implemented as remote radio heads. As shown in FIG. 1, the cellular base station 10 includes an equipment enclosure 20 and a tower 30. The equipment enclosure 20 is typically located at the base of the tower 30, and a baseband unit 22 and a power supply 26 are located within the equipment enclosure 20. The baseband unit 22 may be in communication with a backhaul communications system 28. A plurality of remote radio heads 24 and a plurality of antennas 32 (e.g., three sectorized antennas 32) are located at the top of the tower 30. While the use of tower-mounted remote radio heads 24 may improve signal quality, it also requires that DC power be delivered to the top of the tower 30 to power the remote radio heads 24.

A fiber optic cable 38 connects the baseband unit 22 to the remote radio heads 24, as fiber optic links may provide greater bandwidth and lower loss transmissions. A power cable 36 is also provided for delivering the DC power signal up the tower 30 to the remote radio heads 24. The power cable 36 may include a first insulated power supply conductor and a second insulated return conductor. The fiber optic cable 38 and the power cable 36 may be provided together in a hybrid power/fiber optic cable 40 (such hybrid cables that carry power and data signals up an antenna tower are commonly referred to as “trunk” cables). The trunk cable 40 may include a plurality of individual power cables that each power a respective one of the remote radio heads 24 at the top of the antenna tower 30. The trunk cable 40 may include a breakout enclosure 42 at one end thereof (the end at the top of the tower 30). Individual optical fibers from the fiber optic cable 38 and individual conductors of the power cable 36 are separated out in the breakout enclosure 42 and connected to the remote radio heads 24 via respective breakout cords 44 (which may or may not be integral with the trunk cable 40) that run between the remote radio heads 24 and the breakout enclosure 42. Stand-alone breakout cords 44 are typically referred to as “juniper cables” or “jumpers.” Coaxial cables 46 are used to connect each remote radio head 24 to a respective one of the antennas 32.

As discussed in co-pending and co-assigned U.S. Patent Publication No. 2015/0155669 to Chamberlain (the disclosure of which is hereby incorporated herein in its entirety), there may be performance advantages (particularly in power enhancement) in introducing capacitive arrangements to the power circuits at the top of the tower, particularly with jumper cables. Other arrangements with other features may also be desirable.

### SUMMARY

As a first aspect, embodiments of the invention are directed to a hybrid jumper cable assembly comprising: a plurality of power conductors; a plurality of optical fibers; a jacket surrounding the power conductors and the optical fibers; a hybrid connector connected with the power conductors and the optical fibers; a power connector connected with the power conductors; an optical connector connected with the optical fibers; and a circuit breaking device electrically connected with one of the plurality of power conductors.

As a second aspect, embodiments of the invention are directed to a hybrid jumper cable assembly comprising: a plurality of power conductors; a plurality of optical fibers; a jacket surrounding the power conductors and the optical fibers; one or more connectors connected with the power conductors and the optical fibers; and a circuit breaking device electrically connected with one of the plurality of power conductors.

### BRIEF DESCRIPTION OF THE FIGURES

FIG. 1 is a simplified, schematic view of a conventional cellular base station in which several remote radio heads are located at the top of an antenna tower.

FIG. 2 is a perspective view of a hybrid jumper cable according to embodiments of the invention that includes both a capacitor and an overvoltage protection (OVP) unit.

FIG. 3 is a perspective view of the hybrid jumper cable of FIG. 2 with the outer conduit removed.

FIG. 4 is an enlarged partial perspective view of the OVP unit of the hybrid jumper cable of FIG. 2.

FIG. 5 is an enlarged perspective view of an alternative OVP unit for the hybrid jumper cable unit of FIG. 2.

FIG. 6 is an enlarged partial perspective view of a hybrid jumper cable according to embodiments of the invention in which an OVP unit is connected to alarm wires.

FIG. 7 is a schematic top view of a hybrid jumper cable assembly according to embodiments of the invention, illustrating various possible locations for a fuse attached to a power conductor.

FIG. 8 is a schematic top view of a hybrid jumper cable assembly according to embodiments of the invention in which the fuse is located on a breakout length of the cable.

FIG. 9 is a schematic top view of a hybrid jumper cable assembly according to embodiments of the invention in which the fuse is located on a breakout length of the cable near the transition tube.

FIG. 9A is a schematic top view of a hybrid jumper cable assembly according to embodiments of the invention in which the power conductors and optical fibers are attached at one end to a breakout pendant or enclosure.

FIG. 9B is a top view of exemplary fuses for the assembly of FIG. 9A.

FIG. 10 is a schematic top view of a hybrid jumper cable assembly according to embodiments of the invention in which the fuse is mounted to the hybrid connector.

FIG. 10A is a perspective view of a hybrid connector usable with the assembly of FIG. 10 showing the installation of the fuse.

FIG. 10B illustrates an exemplary crimp-stye fuse FS that may be employed with hybrid connectors 502 or connected breakout lengths.

FIG. 11 is a schematic top section view of a hybrid jumper cable assembly according to embodiments of the invention in which the fuse is located within the transition tube.

FIG. 11A is a schematic top section view of the assembly of FIG. 11 with the optical fibers removed for clarity.

FIGS. 11B and 11C are perspective views of exemplary fuses for the assembly of FIG. 11.

FIG. 12 is a top view of an adapter that can be used with a hybrid connector, wherein the adapter includes a fuse.

FIG. 12A is a top view of an exemplary fuse for the assembly of FIG. 12.

FIG. 13 is a top view of a hybrid connector assembly with a protective flexible conduit.

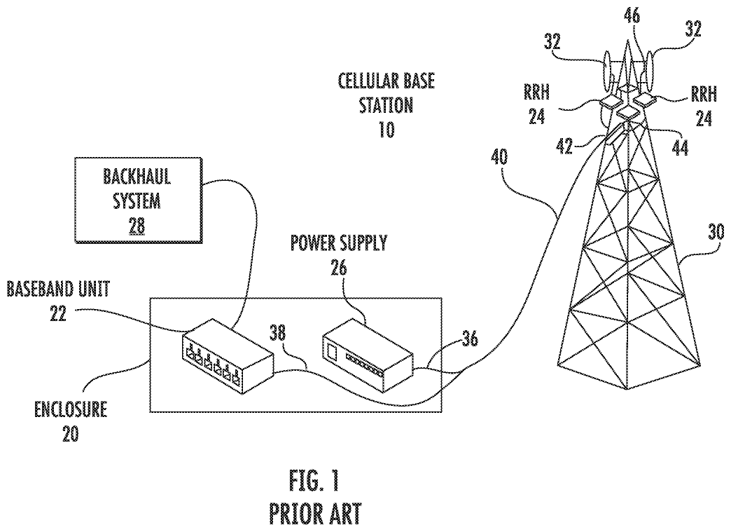

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

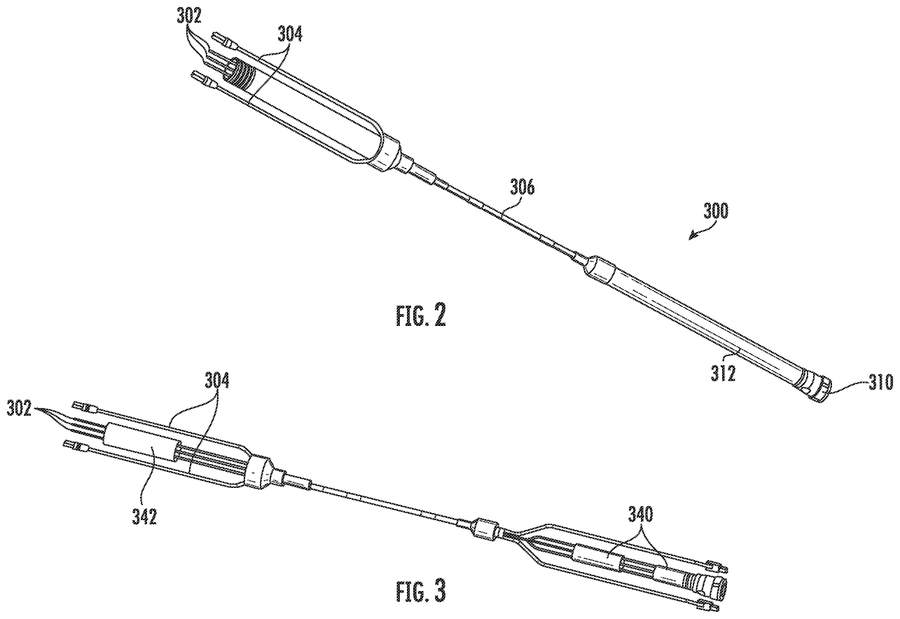

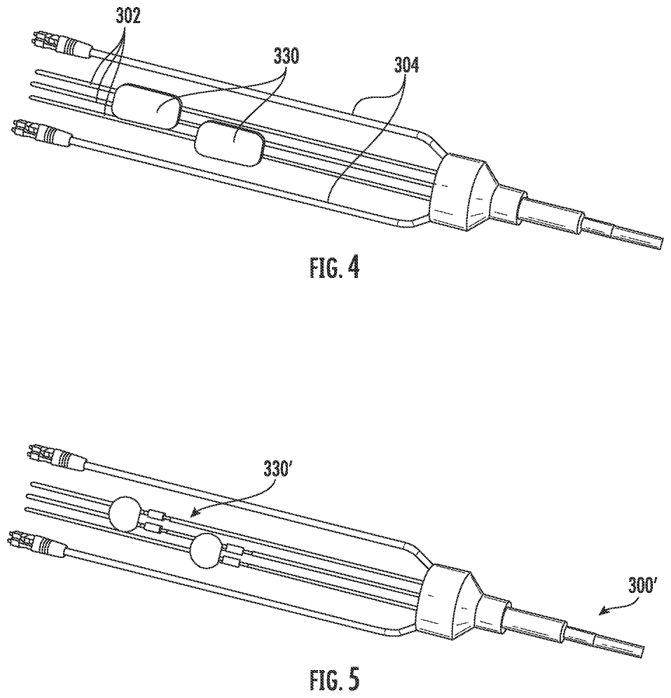

Referring now to FIGS. 2-4, an embodiment of a hybrid jumper cable, designated broadly at 300, is shown therein. The hybrid jumper cable 300 includes three power conductors 302 and two optical fibers 304 residing within a jacket 306, and also includes a hybrid connector 310 at one end. Capacitors (not shown) reside within ruggedized tubes 340 (FIG. 3), which in turn reside within a conduit 312. As shown in FIG. 4, at the opposite end the hybrid cable 300 includes an OVP unit 330, which is connected to the power conductors 304 (one of which is a ground wire). A ruggedized tube 342 covers the OVP unit 330. In this instance the hybrid jumper cable 300 can provide overvoltage protection, rather than such capability being housed in the RRU or other equipment. Another embodiment of a hybrid jumper cable 300′ shows an OVP unit 330′ of a different configuration (see FIG. 5).

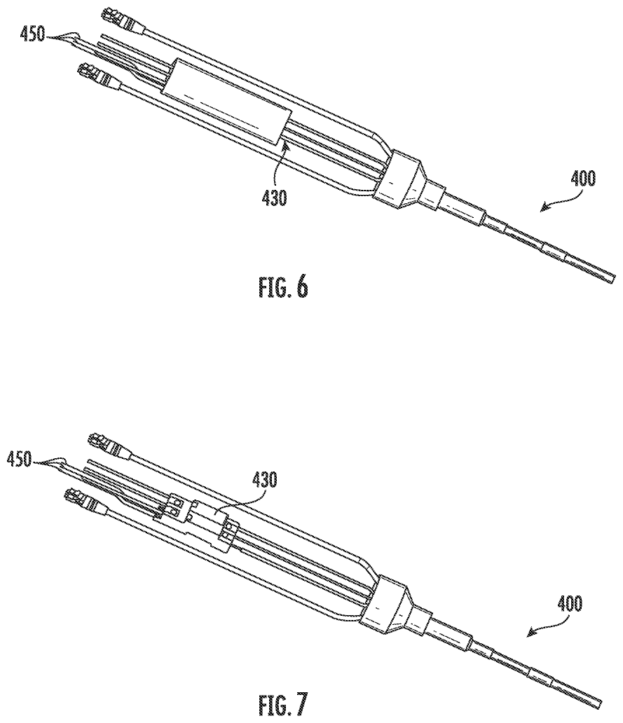

A still further embodiment of a hybrid jumper cable is illustrated in FIGS. 6 and 7 and designated broadly at 400. The hybrid jumper cable 400 is similar to the hybrid jumper cable 300 shown in FIGS. 2-4, with the exception that the OVP unit 430 is of a different configuration, and three alarm wires 450 are attached to the OVP unit 430. This configuration can provide a warning signal to an external alarm unit (not shown), such as an audio alarm or visual indicator. Exemplary devices such as those shown in FIGS. 2-7 are described in detail in U.S. Patent Publication No. 2019/0140402 to Islam, the disclosure of which is hereby incorporated herein by reference in full.

For hybrid cable assemblies with a hybrid connector on one end of the assembly, as are illustrated and described in connection with FIGS. 2-7, in some instances a fuse or other circuit breaking device may be included on the hybrid cable's conductor(s) (rather than an OVP unit) in order to protect the cable from overheating to minimize fire hazards. In many embodiments, a single fuse on a single conductor is sufficient to provide the needed protection. Different concepts that include a fuse are discussed below.

FIG. 8 schematically illustrates a breakout assembly 500 with two hybrid connectors 502 at one end and, at the other end, four optical connectors 504 and a power connector 506. As is shown in FIG. 8, a fuse may be added to a conductor in different places on the assembly 500. For example, the fuse may be included inside the power connector 506 (shown at A), within the breakout length 510 of the power cable 511 between the breakout transition tube 512 and the power connector 506 (shown at B), within the transition tube 512 where the optical fibers are broken out from the power conductors (shown at C), within the transition tube 520 wherein hybrid cables are broken out (shown at D), within the breakout length 522 of the hybrid cable 524 (shown at E), or in the hybrid connector 502 (shown at F). Further explanation of some of these concepts is set forth below.

The fuse may be any known to those of skill in this art to be suitable for halting current flow under certain conditions (e.g., a voltage spike).

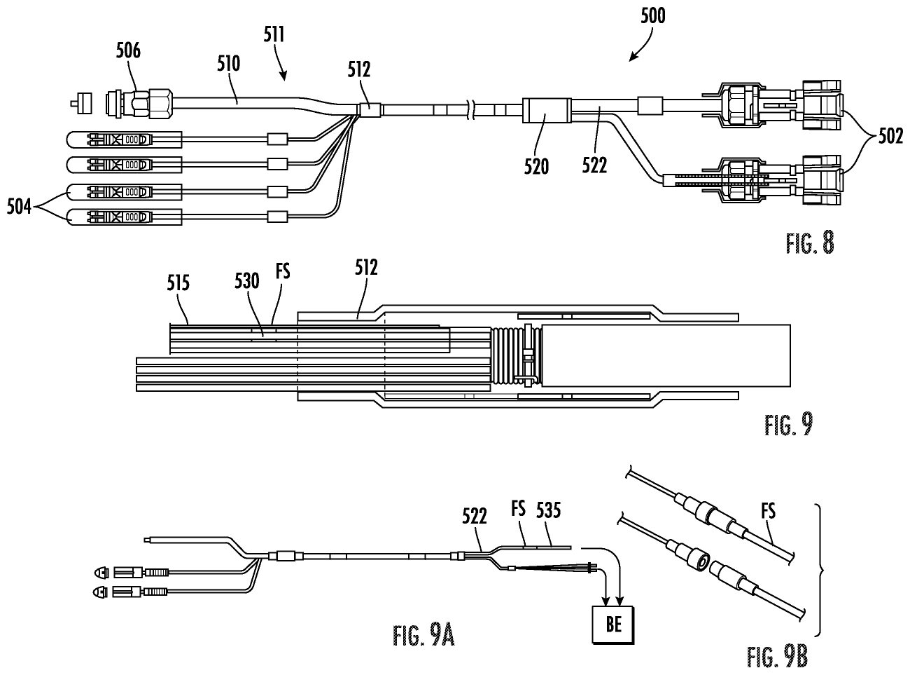

FIG. 9 illustrates a fuse FS added to a power conductor 530 within the breakout length 510 (scenario B in FIG. 8). In this instance, an inline fuse FS is connected to power conductor 530. In the illustrated instance, the fuse FS is positioned very close to the transition tube 512 (and within the jacket 515 of the breakout length 510). Similar arrangements can be employed for the power conductors of interest in the breakout length 522 (shown in scenario E in FIG. 8). In some instances, the breakout length 522 may be protected with a flexible conduit or tube. FIG. 9A illustrates an alternative for scenario E in which the fuse FS is attached to a power conductor 535 within the breakout length 522, but the power conductor 535 is attached directly to a breakout enclosure or pendant BE rather than to a hybrid connector. An exemplary fuse FS is shown in FIG. 9B.

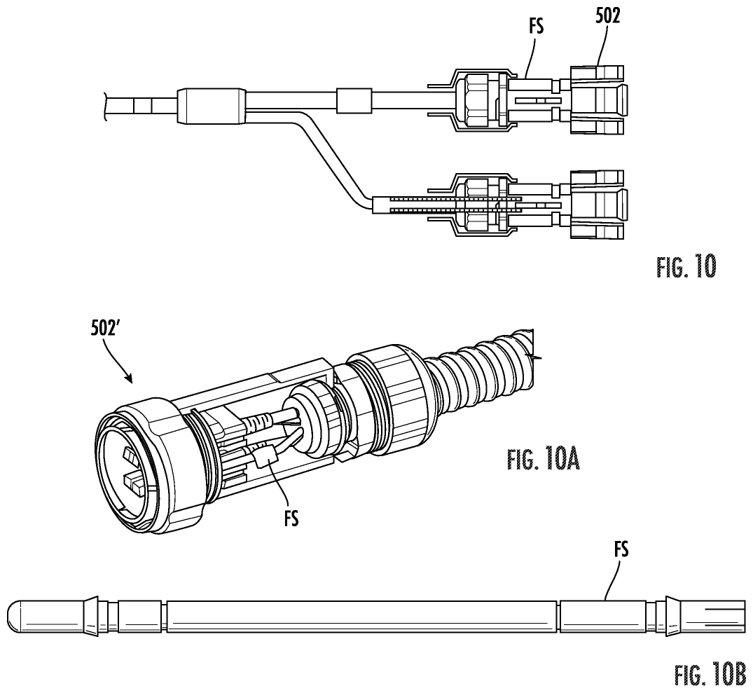

FIG. 10 illustrates the inclusion of a fuse FS inside a hybrid connector 502 (scenario F in FIG. 8). In this instance, an inline fuse may include a copper conductor attachment feature and may be attached directly to one of the power terminals of the connector 502 via soldering, crimping or threaded fastening. The fuse FS may be insulated once connected. FIG. 10A provides an alternative view of a hybrid connector 502′ in which the fuse FS is visible. FIG. 10B illustrates an exemplary crimp-stye fuse FS that may be employed with hybrid connectors 502 or connected breakout lengths. FIG. 13 illustrates the hybrid connector 502′ as part of a hybrid cable assembly that includes conduit 523 to provide protection and/or flexibility. The fuse may be added to the connector itself or the attached breakout length within the conduit.

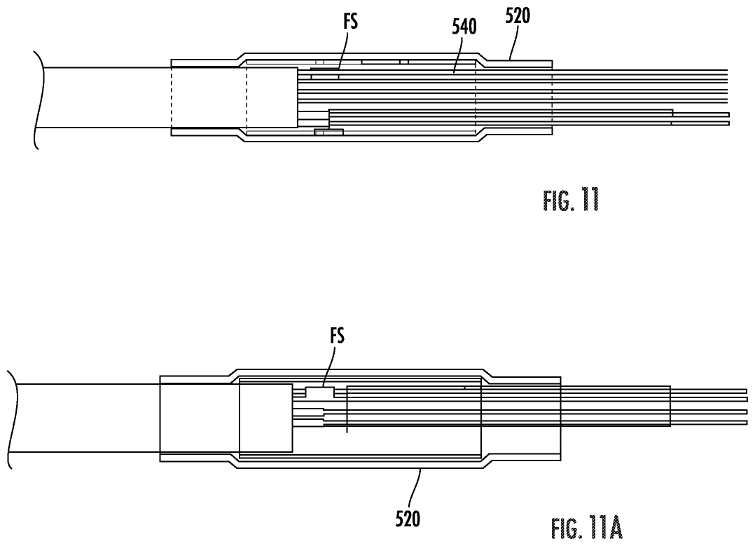

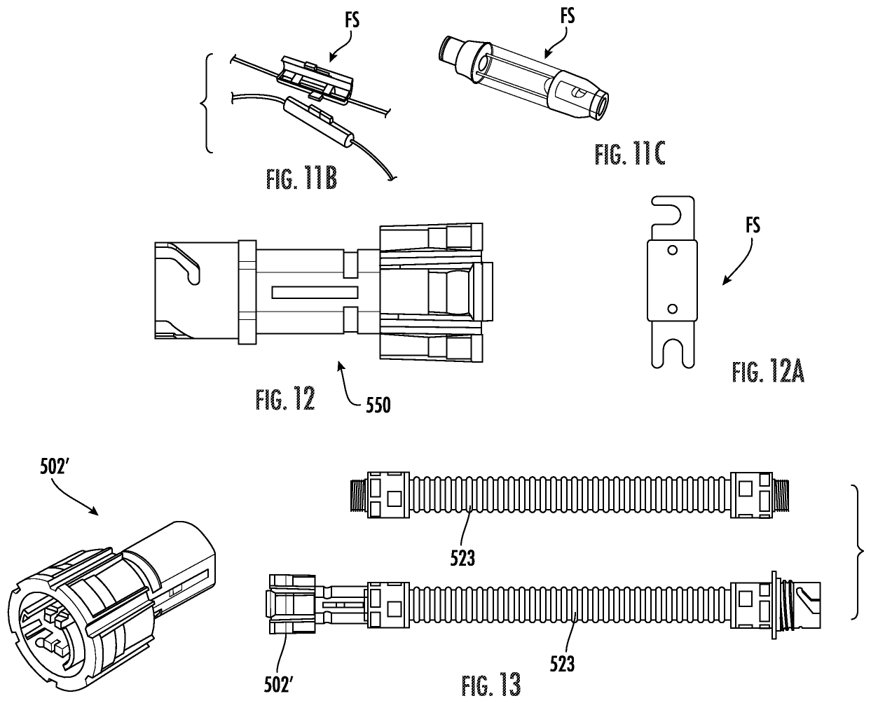

FIG. 11 illustrates a fuse FS that is added to a power conductor 540 within the transition tube 520 (scenario D in FIG. 8). In this instance, the fuse FS is connected to one of the power conductors 540 within the transition tube 520. As shown in FIG. 11, the fuse FS is positioned near one end of the transition tube 520, but may be positioned in any location within the transition tube 520. FIG. 11A shows the same arrangement, but with the optical fibers removed for clarity. A similar arrangement may be used within the transition tube 512 (scenario C in FIG. 8). Exemplary fuses FS are shown in FIGS. 11B and 11C.

FIG. 12 illustrates a concept in which a fuse FS is mounted within an adapter 550 that can, in turn, be attached to a connector. An exemplary fuse FS for use in the adapter 550 is shown in FIG. 12A. The adapter 550 may be male-male, female-female, or male-female.

Although jumper cables are discussed herein, the configuration could also be used in trunk cables or the like. Also, those skilled in this art will appreciate that jumper cables according to embodiments of the invention may lack optical fibers and provide power only (with corresponding power connectors). Alternatively, a hybrid jumper cable may have both power and fiber optic connectors rather than a hybrid connector as shown. Further, in cables with multiple circuits of power conductors (e.g., multiconductor hybrid trunk cables), a fuse or other circuit breaking device may be included for each of the multiple circuits.

Moreover, the fuses FS shown herein are merely exemplary and not intended to be limiting. Types of exemplary fuses include inline fuses, crimp-style fuses, threaded lock-style fuses and the like.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A hybrid jumper cable assembly, comprising:
a plurality of power conductors;
a plurality of optical fibers;
a jacket surrounding the power conductors and the optical fibers;
a hybrid connector connected with the power conductors and the optical fibers;
a power connector connected with the power conductors;
an optical connector connected with the optical fibers; and
a circuit breaking device electrically connected with one of the plurality of power conductors.

2. The hybrid jumper cable assembly defined in claim 1, further comprising a transition area where the optical fibers are broken out from the power conductors.

3. The hybrid jumper cable assembly defined in claim 2, wherein the circuit breaking device is located in the transition area.

4. The hybrid jumper cable assembly defined in claim 2, wherein the circuit breaking device is located between the power connector and the transition area.

5. The hybrid jumper cable assembly defined in claim 2, wherein the circuit breaking device is located between the hybrid connector and the transition area.

6. The hybrid jumper cable assembly defined in claim 1, wherein the circuit breaking device is attached directly to the hybrid connector.

7. The hybrid jumper cable assembly defined in claim 1, wherein the circuit breaking device is attached directly to the power connector.

8. The hybrid jumper cable assembly defined in claim 1, wherein the circuit breaking device is a fuse.

9. A hybrid jumper cable assembly, comprising:
a plurality of power conductors;
a plurality of optical fibers;
a jacket surrounding the power conductors and the optical fibers;
one or more connectors connected with the power conductors and the optical fibers; and
a circuit breaking device electrically connected with one of the plurality of power conductors.

10. The hybrid jumper cable assembly defined in claim 9, wherein the one or more connectors is a hybrid connector attached to the power conductors and the optical fibers.

11. The hybrid jumper cable assembly defined in claim 10, wherein the circuit breaking device is attached directly to the hybrid connector.

12. The hybrid jumper cable assembly defined in claim 9, wherein the one or more connectors is a power connector attached to the power conductors.

13. The hybrid jumper cable assembly defined in claim 12, wherein the circuit breaking device is attached directly to the power connector.

14. The hybrid jumper cable assembly defined in claim 9, further comprising an adapter attached to the one or more connectors, and wherein the circuit breaking device is located in the adapter.

15. The hybrid jumper cable assembly defined in claim 9, further comprising a transition area where the optical fibers are broken out from the power conductors.

16. The hybrid jumper cable assembly defined in claim 15, wherein the circuit breaking device is located in the transition area.

17. The hybrid jumper cable assembly defined in claim 9, wherein the hybrid jumper cable has only one circuit breaking device attached to a power conductor.

18. The hybrid jumper cable assembly defined in claim 9, wherein only one of the plurality of power conductors has a circuit breaking device mounted thereon.

19. The hybrid jumper cable assembly defined in claim 9, wherein the circuit breaking device is a fuse.
